(19) United States
(12) Patent Application Publication
(10) Pub. No.: US 2025/0297660 A1
(43) Pub. Date: Sep. 25, 2025

(54) ELASTIC BEARING ELEMENT

(71) Applicant: Vibracoustic SE, Weinheim (DE)

(72) Inventor: Werner Hettler, Mannheim (DE)

(21) Appl. No.: 18/947,590

(22) Filed: Nov. 14, 2024

(30) Foreign Application Priority Data
Nov. 15, 2023 (DE) 10 2023 131 725.3

(51) Int. Cl. F16F 1/387; F16F 1/38

(52) U.S. Cl. CPC F16F 1/3876; F16F 1/3842; F16F 2226/04; F16F 2228/08

(57) ABSTRACT

The elastic mount element 1 according to the invention for supporting loads in a vehicle, having a longitudinal axis X and a spring element 40, wherein the spring element 40 comprises a mount core 41 and an elastomer 42 vulcanized onto the mount core 41, wherein the elastomer 42 forms at least one lug 43, which projects from the mount core 41, a cartridge 20, which has an undersize relative to the spring element 40 and radially prestresses the spring element 40, wherein the cartridge 20 has a side 21 facing the spring element and a side 22 facing away from the spring element, and a receptacle 10 having an insertion opening for inserting the cartridge 20, wherein the receptacle 10 has a first axial spring travel limiter 11 toward a first end face and a second axial spring travel limiter 12 toward a second end face, and the cartridge 20 is received into the receptacle 10.

### CROSS-REFERENCE TO RELATED APPLICATIONS

This application claims priority to German Patent Application No. DE 10 2023 131 725.3, filed on Nov. 15, 2023, the contents of which is hereby incorporated by reference in its entirety.

### TECHNICAL FIELD

The invention relates to an elastic mount element for supporting loads in a vehicle and to an assembly method.

### BACKGROUND

Vehicle construction is subject to a continuous dynamic change in requirements, which must be harmonized with costs and physical limits. New propulsion systems or components regularly pose new requirements on the installation space and damping properties of mounts.

Elastomer mounts in the form of bushes are widely used in vehicle construction. It is prior art that the spring rates in all three spatial directions can be influenced within limits by means of gaps in the rubber contour.

DE 198 59 067 A1 describes one such rubber mount with attachment on one side.

### SUMMARY

Aspects and features of the invention are disclosed herein.

The elastic mount element according to the invention for supporting loads in a vehicle, having a longitudinal axis and a spring element, wherein the spring element comprises a mount core and an elastomer vulcanized onto the mount core, wherein the elastomer forms at least one lug, which projects from the mount core, a cartridge, which has an undersize relative to the spring element and radially prestresses the spring element, wherein the cartridge has a side facing the spring element and a side facing away from the spring element, and a receptacle having an insertion opening for inserting the cartridge, wherein the receptacle has a first axial spring travel limiter toward a first end face and a second axial spring travel limiter toward a second end face, and the cartridge is received into the receptacle.

Particularly in the case of unilaterally attached spring elements, high spring rates with a pronounced linear profile of the stiffness can be achieved only with relatively thick elastomer springs, which may also be referred to as lugs or spring elements, which must have large prestresses in the respective direction. High spring rates in all three spatial directions therefore require a high prestress in precisely these three spatial directions. Delicate lugs promote an initial linearity of the spring rates.

The at least one lug arranged around the mount core, which projects from the melt core, makes it possible to dimension spring rates in all radial directions and thus, for example, to provide a different spring rate in a direction transverse to the direction of travel to that in the direction of travel. The cartridge prestresses the spring element in that it has an undersize relative to the spring element in at least one radial direction. Thus, as the spring element is inserted into the cartridge, the elastomer, with its at least one lug projecting from the mount core, is compressed and the radial spring rates are set. In this context, radial calibration of the spring element is also referred to. Here, the spring rate depends on the geometry of the elastomer and the undersize of the cartridge.

Radial prestressing increases the stiffness of a spring element and simultaneously holds it in position. The spring element does not have to be bonded to the cartridge by means of vulcanization. It is held, preferably exclusively, by nonpositive engagement and/or positive engagement in the cartridge.

Cartridge-type construction saves installation space and creates a simple and reliable connection to a corresponding receptacle. This reduces the risk of damage during assembly without reducing the prestress. Moreover, the risk of incorrect assembly is reduced by a defined cartridge-receptacle connection.

The cartridge is manufactured from plastic, for example.

The receptacle is manufactured, for example, from a metal, in particular from diecast aluminum.

A receptacle allows axial fixing or prestressing independently of radial prestressing, and therefore the installation of the spring element in the cartridge comprises only radial prestressing, and the insertion of the cartridge into the receptacle comprises the axial fixing or prestressing. It is thus not necessary to apply forces simultaneously in all three spatial directions, and assembly is made easier.

The cartridge can be fixed by positive engagement and/or frictional engagement in the receptacle, for example.

Axial spring travel limitation by means of an annular supporting element on the two end faces at the axial ends of the receptacle limits the spring travel in that the spring element cannot be displaced axially beyond the supporting elements in the case of the maximum deformation of the lugs.

The mount element can have an axial through hole for screwing in a load. The mount element can have other fastening means for connecting it to a load and/or to a component for supporting a load.

In one technically advantageous refinement, the first axial spring travel limiter and the second axial spring travel limiter prestress the elastomer, at least in some region or regions, in an assembled state.

An assembled state describes the state in which the elastic mount element itself has been assembled, i.e. all the steps of the production method according to the invention have taken place.

The prestressing by the upper and the lower axial spring travel limiter, in combination with the at least one projecting lug, enables the axial spring rate to be dimensioned. An axial prestress can only arise if either the at least one lug has an axial oversize relative to the cartridge or if it is forced axially beyond the cartridge by the radial prestress.

In another technically advantageous refinement, the lug is interrupted in at least one spatial direction by at least one gap.

Gaps allow further dimensioning of the spring rates in each spatial axis without neglecting the setting up of the desired progression profile and of the definitive travel limitation. In this case, gaps can be provided around the entire circumference and/or in some portion or portions in the circumferential direction and/or in the axial direction as cutouts over the entire radial thickness and/or as a recess over part of the radial thickness. It is thus possible to use the same cartridges and mount cores with different lug geometries in order to provide different spring rates, depending on the application. This leads to higher production numbers of uniform components and therefore reduces production costs.

In another technically advantageous refinement, the mount element has a spring rate in the axial direction and at least two spring rates in the radial direction, and the spring rates in the axial direction are between 20% and 600%, preferably between 100% and 200%, particularly preferably 140%, of the lower of these at least two spring rates in the radial direction.

By means of an axial spring rate between 20% and 600%, preferably between 100% and 200%, particularly preferably 140%, of the lower of at least two radial spring rates, the modern requirements of electric vehicles are taken into account. The high weights of energy storage units, in particular, pose challenges to conventional mount elements. By means of an axial spring rate of up to 600% of the at least two radial spring rates, additional requirements can be met. Configuration with an axial spring rate of 20% of the lower of the at least two radial spring rates takes account of different requirements of complex vehicle systems. This broad range of spring rate conditions with very largely the same components reduces costs and increases the availability of components.

In another technically advantageous refinement, the at least one lug of the spring element is compressed by the cartridge by 10% to 50% of its radial extent, preferably 10% to 20% of its radial extent.

The particularly high calibration rate which prestressing of the at least one lug provides brings the spring element into a working position in which a negative spring travel is imposed upon it. As a result, the spring element can be compressed in all directions by a load without the opposite side of the spring element losing contact with the cartridge, and it achieves defined spring rates in all radial directions, depending on the prestress. Moreover, because of this, there remains a compressive prestress in the elastomer in all load situations, and this favors a long life of the spring element.

In another technically advantageous refinement, a central lug is provided, which projects radially from the mount core and may also be referred to as a radial stop.

In contrast to the other lugs, this central lug is preferably not radially and/or axially prestressed and preferably forms an air gap between the central lug and the cartridge. This un-prestressed lug can serve as a radial end stop. As a result, the stiffness profile of the elastic mount element can initially have a linear profile in the radial direction, which then continues progressively, that is to say with a clear jump in stiffness, upon contact between the central lug and the cartridge, once the air gap has been crossed. Moreover, this central lug limits the compressive loading of the other lugs on account of radial deflections and thus increases their life.

In another technically advantageous refinement, at least one insert element is arranged at contact points between the spring element and the cartridge and/or between the spring element and the receptacle.

By means of at least one insert element, the prestress can be further increased, and the stiffness of the elastic mount element can thus also be further increased. Insert elements increase the undersize of the cartridge and/or of the receptacle, and therefore the spring element is compressed even more in the radial and/or axial direction. Thus, identical components can be adapted by simple means for mount elements of different stiffness, and this reduces production costs. Insert elements can be arranged all round or in some portion or portions between the elastomer of the spring element and the cartridge and/or between the elastomer and the receptacle, and can thus change the stop action and/or increase the prestress.

In another technically advantageous refinement, the insert element has at least one holding element and/or corresponds to at least one holding element of the elastic mount element.

In order to avoid displacement of the at least one insert element in the case of maximum load relief, i.e. maximum loading of the opposite side of the spring element, the at least one insert element can have at least one holding element, such as, but without limitation thereto, grooves, projections, ribs. Thus, if loading leads to the spring element losing contact on one side with the at least one insert element, the at least one insert element continues to be held in its position by its holding element.

In addition, the elastic mount element can also have at least one holding element, which holds the at least one insert element in position in the event of loading of the opposite side of the spring element.

It is also possible for both the at least one insert element and the elastic mount element to have at least one holding element, which hold the at least one insert element in position together or in parallel.

In another technically advantageous refinement, the at least one insert element is arranged at edges facing the cartridge, and/or on the outer surface of the at least one lug which faces the first axial spring travel limiter and/or the second axial spring travel limiter.

By virtue of its arrangement between the lug and the cartridge and/or between the lug and the upper and lower axial travel limiters, the at least one insert element can be more easily held in position, thereby enabling possible holding elements to be made simpler or to be eliminated entirely.

In another technically advantageous refinement, the insert element is embedded into the at least one lug.

Embedding in the at least one lug further simplifies assembly since there is no need to arrange an additional part between the cartridge and the spring element or the receptacle and the spring element.

In another technically advantageous refinement, the insert element and/or the insert element embedded into the lug are/is connected materially to the elastomer, e.g. by means of vulcanization.

An insert element connected materially to the elastomer can further increase stiffness. Moreover, assembly is further simplified since no elastomer can become trapped between the cartridge and the receptacle during assembly.

In another technically advantageous refinement, the mount core is configured in such a way that the mount core has a radial oversize in the axial direction relative to the first axial spring travel limiter and/or the second axial spring travel limiter, even without the vulcanized-on elastomer, and has an undercut in at least one axial direction, at least in some region or regions.

A mount core which does not fit in the axial direction through the axial spring travel limiters of the receptacle, even without the vulcanized-on elastomer, facilitates axial travel limitation since the spring element can be deformed to a lesser extent due to the stable mount core.

As a particular advantage, the mount core does not fit through the supporting elements of the receptacle, even when there is a defect in the elastomer or in the connection to the elastomer, and therefore a failsafe design is provided.

A method for assembling an elastic mount element according to the invention comprises the following steps:
a. radial stressing of a spring element by inserting the spring element into a cartridge to produce a preassembly,
b. insertion of the cartridge into a receptacle and thus axial stressing of the spring element to produce an elastic mount element.

The method for assembling an elastic mount element according to the invention separates the prestressing of the spring element in the radial direction and the prestressing of the spring element in the axial direction. The radial prestressing of the spring element can therefore take place by pressing it axially into the cartridge in a first step. In a second step, the radially prestressed spring element can be inserted with the cartridge into the receptacle in order in this way to achieve an axial prestress as well. The separation of these two steps reduces the assembly effort, reduces the simultaneously required forces when prestressing the spring element, and thus also reduces the risk of damage or assembly errors.

### BRIEF DESCRIPTION OF THE DRAWINGS

Further features, details and advantages of the invention can be derived from the wording of the claims and from the following description of exemplary embodiments with reference to the drawings. In the drawings:

FIG. 1 shows a schematic section through an elastic mount element

FIG. 2 shows a schematic section through an elastic mount element

FIG. 3 shows a perspective view of a schematic elastic mount element

FIG. 4 shows a perspective view of a schematic preassembly

FIG. 5 shows a perspective view of a spring element

FIG. 6 shows a perspective view of a cartridge

FIG. 7 shows a schematic section through an elastic mount element with insert elements

FIG. 8 shows a schematic section through an elastic mount element with insert elements

### DETAILED DESCRIPTION

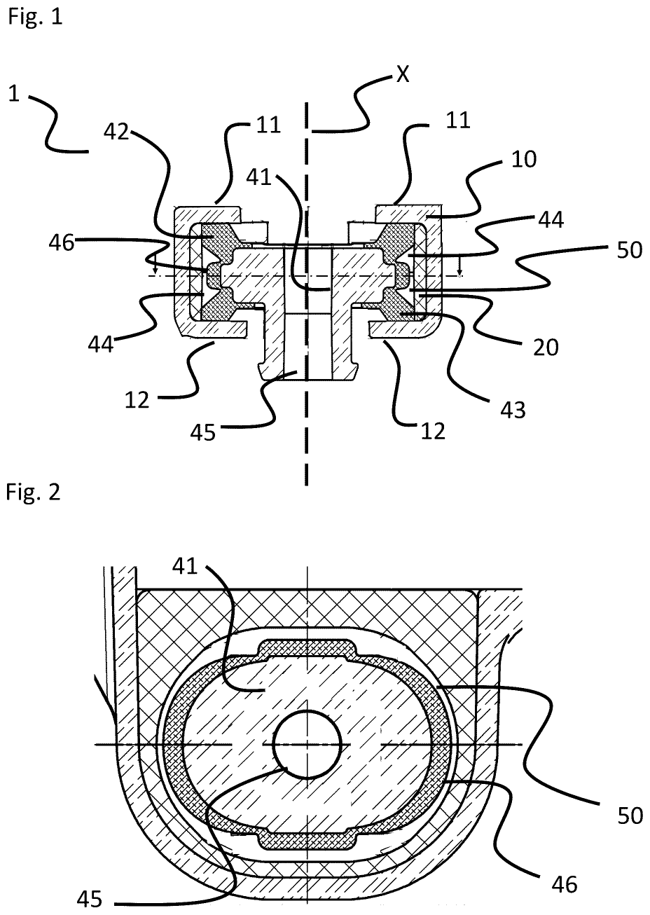

FIG. 1 shows a schematic section through an elastic mount element 1 with a longitudinal axis X and a receptacle 10, which receives a cartridge 20 and an elastomer 42 with an axially prestressed lug 43 and a central lug 46. The receptacle 10 forms a first axial spring travel limiter 11 and a second axial spring travel limiter 12. The lugs 43 are interrupted by gaps 44. The cartridge 20 radially prestresses the lugs 43. The elastomer 42 is vulcanized onto a mount core 41. The mount core 41 has a through hole 45. An air gap 50 is formed between the central lug 46 and the cartridge 20.

FIG. 2 shows a schematic section through an elastic mount element 1 with a section plane through the central lug 46 of FIG. 1. The encircling central lug 46 is vulcanized onto the mount core 41 and has a through hole 45. An air gap 50 is formed between the central lug 46 and the cartridge 20.

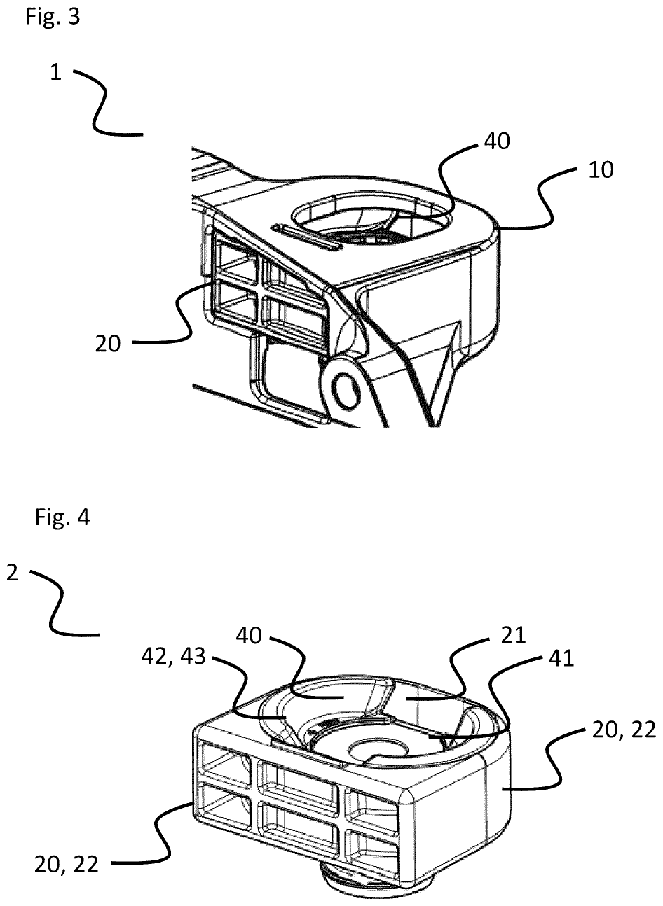

FIG. 3 shows a perspective view of a schematic elastic mount element 1 with a receptacle 10, which receives a cartridge 20 with a spring element 40.

FIG. 4 shows a perspective view of a schematic preassembly 2 with a cartridge 20 and a spring element 40. The cartridge 20 has a side 21 facing the spring element 40 and a side 22 facing away from the spring element 40. The spring element 40 has a mount core 41 with a vulcanized-on elastomer 42, wherein the elastomer 42 forms lugs 43, which project from the mount core 41. The cartridge 20 radially prestresses the spring element 40.

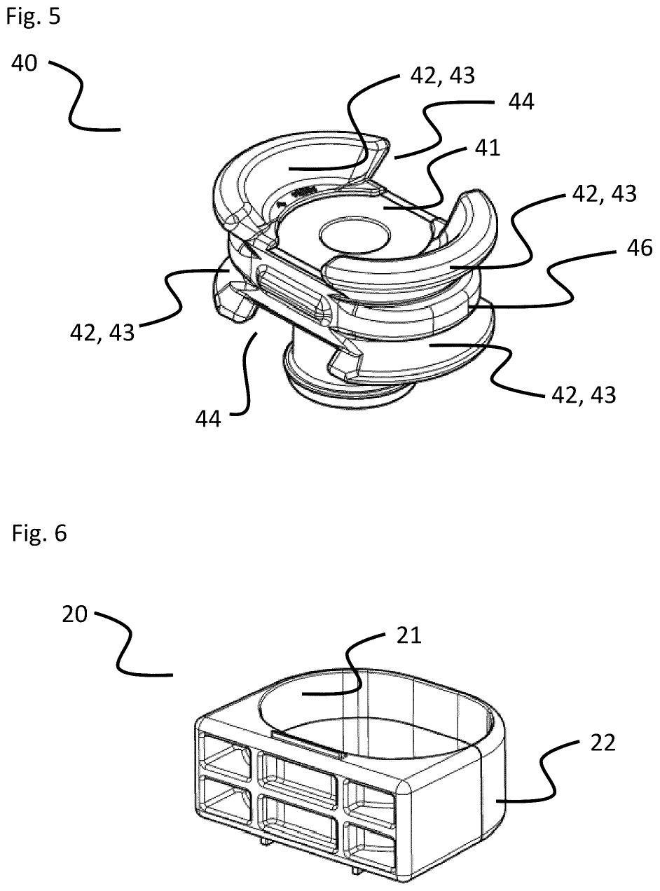

FIG. 5 shows a perspective view of a schematic spring element 40 with an elastomer 42 that forms lugs 43, which include an encircling central lug 46 interrupted by gaps 44. The elastomer 42 is vulcanized onto the mount core 41.

FIG. 6 shows a perspective view of a schematic cartridge 20 with a side 21 facing the spring element and a side 22 facing away from the spring element.

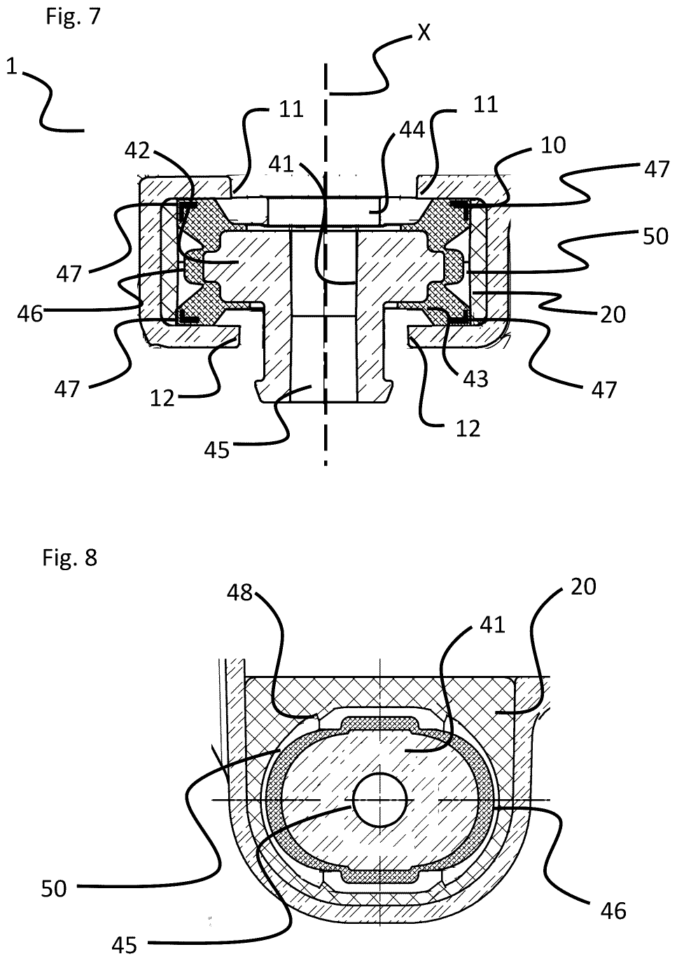

FIG. 7 shows a schematic section through an elastic mount element 1 with a longitudinal axis X and a receptacle 10, which receives a cartridge 20 and axially prestresses an elastomer 42 with a lug 43 and a central lug 46. The receptacle 10 forms a first axial spring travel limiter 11 and a second axial spring travel limiter 12. The lugs 43 are interrupted by gaps 44. The cartridge 20 radially prestresses the lugs 43. The elastomer 42 is vulcanized onto a mount core 41. Insert elements 47 are embedded into the elastomer 42, in the lugs 43, between the receptacle 10, the cartridge 20 and the spring element 40. The insert element 47 and the elastomer 42 are connected materially by means of vulcanization. The mount core 41 has a through hole 45. An air gap 50 is formed between the central lug 46 and the cartridge 20.

FIG. 8 shows a schematic section through an elastic mount element 1 with a section plane through the central lug 46 of FIG. 7. The encircling central lug 46 is vulcanized onto the mount core 41 and has a through hole 45. Holding elements 48 are arranged on the cartridge 20. An air gap 50 is formed between the central lug 46 and the cartridge 20.

The invention is not restricted to one of the above-described embodiments but can be modified in a variety of ways.

All the features and advantages which emerge from the claims, the description and the drawing, including design details, spatial arrangements and method steps, may be essential to the invention either per se or in a wide variety of combinations.

1. An elastic mount element (1) for supporting loads in a vehicle, having a spring element (40), comprising:
a mount core (41),
an elastomer (42) vulcanized onto the mount core (41), wherein the elastomer (42) forms at least one lug (43), which projects from the mount core (41),
a cartridge (20), which has an undersize relative to the spring element (40) and radially prestresses the spring element (40), having:
a side (21) facing the spring element,
a side (22) facing away from the spring element,
and a receptacle (10) having an insertion opening for inserting the cartridge (20), wherein the receptacle (10) has a first axial spring travel limiter (11) toward a first end face and a second axial spring travel limiter (12) toward a second end face, and the cartridge (20) is received into the receptacle (10);
wherein the mount element has a longitudinal axis (X).

2. The elastic mount element (1) as claimed in claim 1, wherein the first axial spring travel limiter (11) and the second axial spring travel limiter (12) axially prestress the elastomer, at least in some region or regions, in the assembled state.

3. The elastic mount element (1) as claimed in one of the preceding claims, wherein the at least one lug (43) is interrupted in at least one spatial direction by at least one gap (44).

4. The elastic mount element (1) as claimed in one of the preceding claims, wherein the mount element (1) has a spring rate in the axial direction and at least two spring rates in the radial direction, and the spring rate in the axial direction is between 20% and 600%, preferably between 100% and 200%, of the lower of these at least two spring rates in the radial direction.

5. The elastic mount element (1) as claimed in one of the preceding claims, wherein the at least one lug (43) of the spring element (40) is compressed by the cartridge (20) by 10% to 50% of its radial extent, preferably 10% to 20%.

6. The elastic mount element (1) as claimed in one of the preceding claims, wherein at least one insert element (47) is arranged at contact points between the spring element (40) and the cartridge (20) and/or between the spring element (40) and the receptacle (10).

7. The elastic mount element (1) as claimed in claim 6, wherein the at least one insert element (47) has at least one holding element (48) and/or corresponds to at least one holding element (48) of the elastic mount element.

8. The elastic mount element (1) as claimed in either of claim 6 or 7, wherein the at least one insert element (47) is arranged at edges facing the cartridge (20), and/or on outer surfaces of the at least one lug (43) which face the first axial spring travel limiter (11) and/or the second axial spring travel limiter (12).

9. The elastic mount element (1) as claimed in one of claims 6 to 8, wherein the at least one insert element (47) is embedded into the at least one lug (43).

10. The elastic mount element (1) as claimed in one of the preceding claims, wherein the mount core (41) is configured in such a way that the mount core (41) has a radial oversize in the axial direction relative to first axial spring travel limiters (11) and/or the second axial spring travel limiters (12), even without the vulcanized-on elastomer (42), and has an undercut in at least one axial direction, at least in some region or regions.

11. A method for assembling an elastic mount element (1) as claimed in one of the preceding claims, comprising the following steps:
a. radial stressing of a spring element (40) by inserting the spring element (40) into a cartridge (20) to produce a preassembly (2),
b. insertion of the cartridge (20) of the preassembly (2) into a receptacle (10) and thus axial stressing of the spring element (40) to produce an elastic mount element (1).
